(19) United States
(12) Patent Application Publication
(10) Pub. No.: US 2013/0025175 A1
(43) Pub. Date: Jan. 31, 2013

(54) Rotating Label Reminder System For A Container

(71) Applicant: Stephen M. Key, Modesto, CA (US)

(72) Inventor: Stephen M. Key, Modesto, CA (US)

(21) Appl. No.: 13/557,143

(22) Filed: Jul. 24, 2012

Related U.S. Application Data
(60) Provisional application No. 61/512,854, filed on Jul. 28, 2011.

(51) Int. Cl. G09F 11/23

(52) U.S. Cl. 40/488

(57) ABSTRACT

The present application is directed to label reminder systems for a container and methods thereof. A base label may be adhered to the container, and reminder information displayed on the base label. A rotatable top label may cover at least a portion of the base label. The top label may have at least two transparent windows allowing a specific segment of the reminder information to be displayed through the transparent windows.

### CROSS-REFERENCE TO RELATED APPLICATIONS

The present application claims priority to provisional U.S. Patent Application Ser. No. 61/512,854, filed on Jul. 28, 2011, titled “Rotating Label to Remind Patients of Length of Time Between Medication Doses,” which is hereby incorporated by reference in its entirety.

### FIELD OF THE INVENTION

The present application is directed generally to labels, and more specifically to labels for consumer product containers that function as a reminder system.

### BACKGROUND

Containers for consumer products have a limited amount of outer surface area for placement of labels on the container. This may pose a challenge to manufacturers of these consumer products to fit all of the information they want to deliver to the consumer, or are required by law to deliver to the consumer, in this limited area. In particular, packaging for prescription medications may be required to specify a significant amount of information concerning dosage and frequency of consumption.

More than three billion prescriptions are written each year in the United States, and an estimated $18 billion is spent on over-the-counter medications. Both prescription and over-the-counter medications are intended to be consumed by a patient according to specific instructions for dosage and frequency. Non-compliance with these instructions has been identified as a major obstacle to the effective delivery of health care. Compliance typically means consuming the correct dosage at the correct frequency as specified in the prescription or on the over-the-counter medication packaging. According to the World Health Organization, only about half of patients with chronic diseases living in developed countries comply with their medication instructions. The reasons for non-compliance are varied, ranging from simple forgetfulness, to confusion, to ambivalence. However, the effects of non-compliance are staggering, resulting in an estimated $290 billion dollars per year in avoidable medical expenses. Additionally, studies have shown that non-compliance results in about 125,000 deaths annually in the United States, and leads to 10-25 percent of hospital and nursing home admissions.

### SUMMARY

The present application is directed to rotating label reminder systems for a container. An exemplary label reminder system may comprise a base label adhered to the container. The base label may have a back surface and a front surface, with reminder information printed on the front surface. The label measurement system may further comprise a top label covering at least a portion of the front surface of the base label. The top label may be rotatable about the base label. In various embodiments, the top label may have two transparent windows allowing at least a portion of the printed reminder information to be displayed through each of the transparent windows. Rotation of the top label may cause the transparent windows to collectively display at least a portion of the printed reminder information.

According to additional exemplary embodiments, the present application may be directed to methods for generating a rotating label reminder system for a container. An exemplary method may comprise adhering a base label having a back surface and a front surface to the container, with reminder information printed on the front surface of the base label. At least a portion of the front surface of the base label may be covered by a rotating top label. At least two transparent windows may be placed within the rotating top label, such that at least two portions of the reminder information may be displayed through the transparent windows. The top label may be allowed to rotate to cause the two transparent windows to collectively display a specific segment of the reminder information.

### BRIEF DESCRIPTION OF THE DRAWINGS

FIG. 1 is a front view of an exemplary label according to various embodiments.

FIG. 2 is a back view of an exemplary label according to various embodiments.

FIG. 3 is a front view of an exemplary label according to various embodiments.

FIG. 4 is a back view of an exemplary label according to various embodiments.

FIG. 5A illustrates a leading edge of an exemplary label affixed to a container according to various embodiments.

FIG. 5B illustrates an exemplary label secured about a container according to various embodiments.

FIG. 6 illustrates an exemplary label secured about a container according to various embodiments.

FIG. 7 illustrates an exemplary base label secured about a container according to various embodiments.

FIG. 8 illustrates a leading edge of an exemplary top label affixed to an exemplary base label according to various embodiments.

FIG. 9 illustrates an exemplary top label affixed to an exemplary base label and partially wrapped about a container according to various embodiments.

FIG. 10 illustrates an exemplary top label with a window affixed to an exemplary base label and partially wrapped about a container according to various embodiments.

FIG. 11 illustrates an exemplary top label with a window secured about a container and a portion of a base label visible through the window according to various embodiments.

FIG. 12 is a front view of a base label according to various embodiments.

FIG. 13 is a front view of a top label according to various embodiments.

FIG. 14 illustrates an exemplary base label secured about a container according to various embodiments.

FIG. 15 illustrates an exemplary base label and top label secured about a container according to various embodiments.

FIG. 16 illustrates an exemplary base label and top label secured about a container according to various embodiments.

FIG. 17 illustrates an exemplary base label and top label secured about a container according to various embodiments

FIG. 18 is a front view of a base label according to various embodiments.

FIG. 19 is a front view of a base label according to various embodiments.

FIG. 20 is a front view of a base label according to various embodiments.

FIG. 21 is a front view of a top label according to various embodiments.

FIG. 22 is a front view of a top label according to various embodiments.

FIG. 23 is an exemplary flow diagram of a method for generating a rotating label reminder system for a container according to various embodiments.

### DETAILED DESCRIPTION

The present application is directed to rotating label reminder systems for a container. An exemplary label reminder system may comprise a base label adhered to the container. The base label may have a back surface and a front surface, with reminder information printed on the front surface. The label reminder system may further comprise a top label covering at least a portion of the front surface of the base label. The top label may be rotatable about the base label. In various embodiments, the top label may have two transparent windows allowing at least two portions of the printed reminder information to be displayed through the transparent windows. Rotation of the top label may cause the transparent windows to collectively display a specific segment of the reminder information.

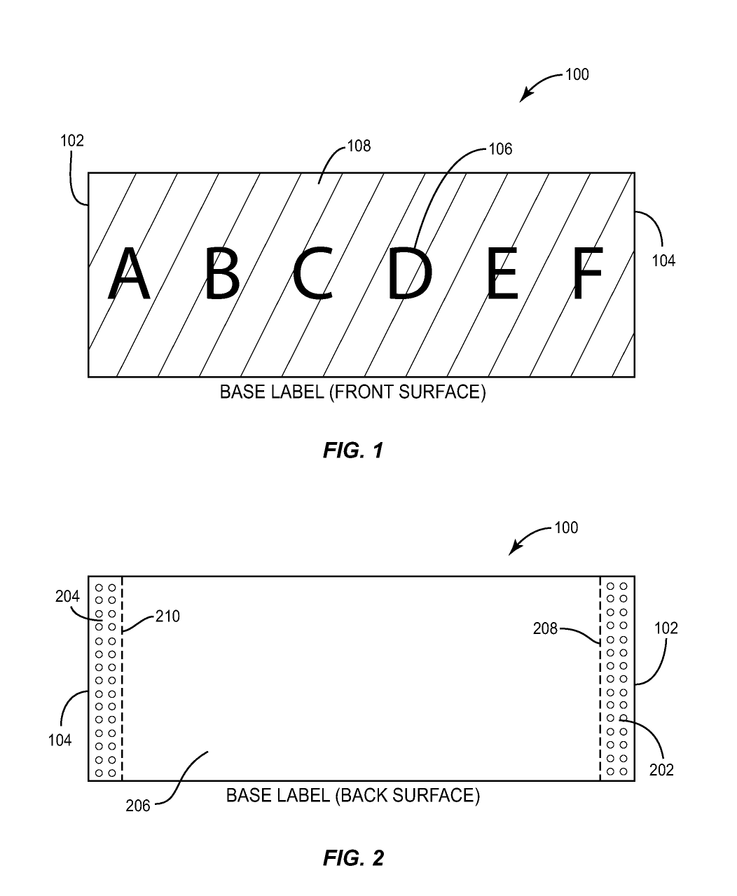

FIG. 1 illustrates various embodiments of a front surface 108 of a base label 100 for an object, such as a medication container, according to various embodiments. The base label 100 comprises a leading edge 102 and a trailing edge 104. While the leading edge 102 is oriented to the left and the trailing edge is oriented to the right as presented in FIG. 1, the orientation of the leading edge 102 and the trailing edge 104 could be reversed depending on which edge is first applied to the object. Both orientations are within the scope of the present disclosure. Base label front surface 108 may comprise writing or other indicia 106 thereon.

As used herein, the leading edge refers to the first edge to be affixed to the object and the trailing edge refers to the second edge to be affixed to the object or the overlapping leading edge. Depending on the orientation of the label and the object when the label is affixed to the object, either edge of the label may be the leading edge. The orientations presented in the figures are for convenience and are not intended to be limiting in any way.

FIG. 2 illustrates various embodiments of a back surface 206 of the base label 100. In various embodiments, the base label back surface 206 comprises two strips of adhesive 202 and 204 on or immediately adjacent to the leading and trailing edges, 102 and 104, respectively. Base label leading edge adhesive 202 may have a boundary 208 defined as its limit on the base label back surface 206. Base label trailing edge adhesive 204 may also have a boundary 210. While FIG. 2 illustrates that the adhesive strips 202 and 204 are generally close to the base label leading and trailing edges 102 and 104, respectively, it is understood that the adhesive strips 202 and 204 may be continuous or discontinuous, and may extend across any portion of the base label back surface 206, including the entire base label back surface 206. In various embodiments, a length of the base label 100 may be selected to be slightly longer than a circumference of the object on which it is placed, such that the trailing edge 104 overlaps the leading edge 102, and the trailing edge 104 is affixed to the leading edge 102. In various embodiments, the length of the base label 100 may be selected to be approximately the same as the circumference of the object on which it is placed, such that the leading edge 102 and the trailing edge 104 do not overlap.

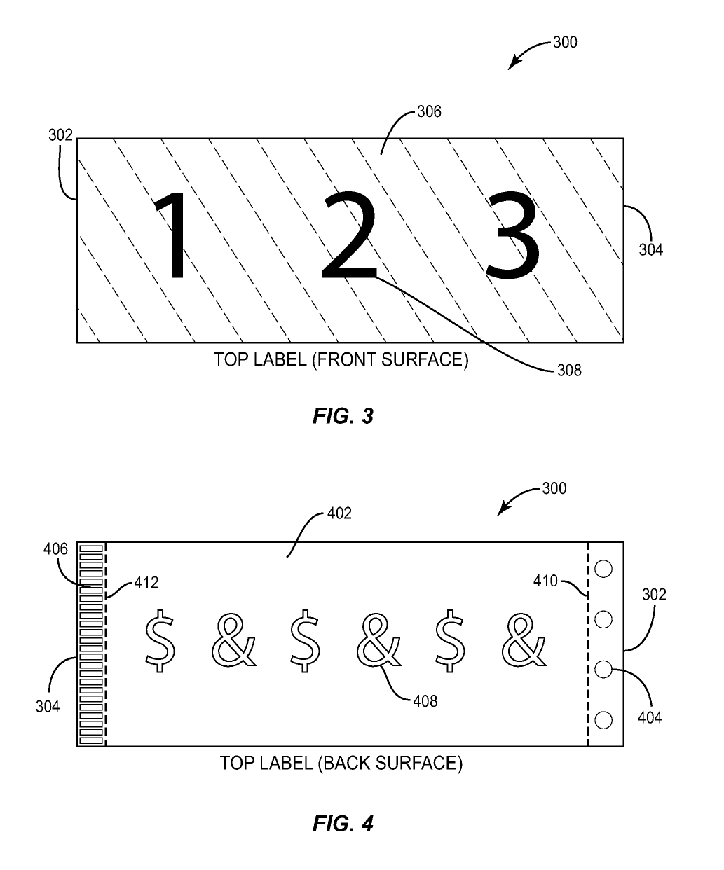

FIG. 3 illustrates various embodiments of a front surface 306 of a top label 300. Top label 300 comprises a leading edge 302 and a trailing edge 304, and indicia 308 may be imprinted on the top label front surface 306.

Various embodiments of a back surface 402 of the top label 300 are illustrated in FIG. 4. The top label back surface 402 may comprise various indicia 408 printed thereon, as well as two strips of adhesive 404 and 406 on or immediately adjacent to the leading and trailing edges, 302 and 304, respectively. Top label leading edge adhesive 404 may have a boundary 410 defined as its limit on the top label back surface 402. Top label trailing edge adhesive 406 may also have a boundary 412. While FIG. 4 illustrates that the adhesive strips 404 and 406 are generally close to the top label leading and trailing edges 302 and 304, respectively, it is understood that the adhesive strips 404 and 406 may be continuous or discontinuous, and may extend across any portion of the top label back surface 402, including the entire top label back surface 402. In various embodiments, the adhesive strips 404 and 406 are confined to areas near the leading and trailing edges 302 and 304, respectively, so as not to obscure or interfere with the top label back surface indicia 408.

The base label adhesive 202, 204 and the top label adhesive 404, 406 may be applied in a variety of patterns as can be appreciated by one skilled in the art. The adhesive 202, 204, 404, 406 may be applied in strips, dots, droplets, circles, rectangles, squares, triangles, lines, and the like, as well as combinations of patterns.

A length of the top label 300 may be selected to be slightly longer than a circumference of the object on which it is placed, such that the top label trailing edge 304 overlaps the top label leading edge 302, and the top label trailing edge 304 is affixed to the top label leading edge 302. In various embodiments, the length of the top label 300 may be selected to be approximately the same as the circumference of the object on which it is placed, such that both the leading edge 302 and the trailing edge 304 do not overlap and are affixed to the base label front surface 108.

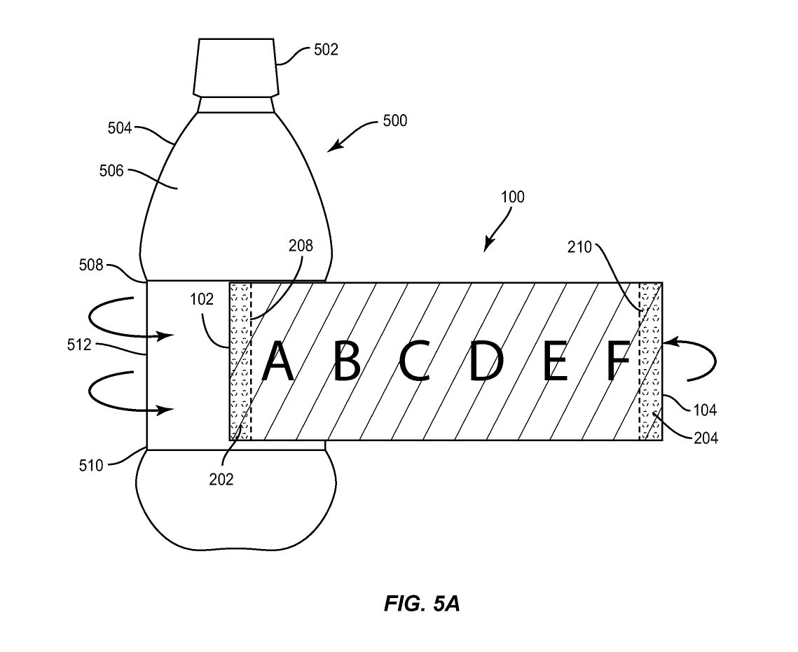

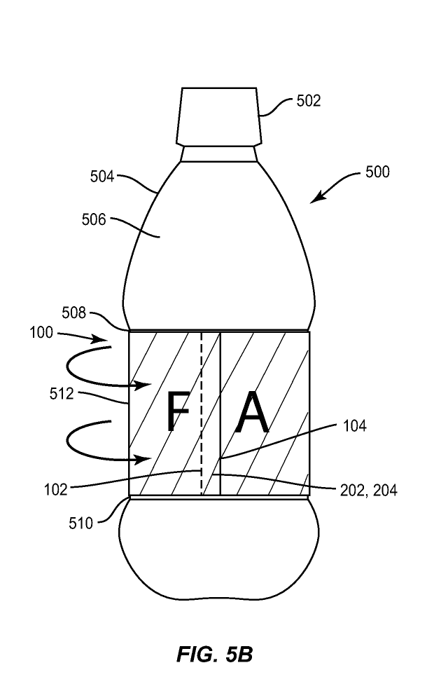

FIG. 5A illustrates the application of the base label 100 to an exemplary container 500 according to various embodiments. The container 500 may be a glass or plastic bottle, or other type of container such as a metal can or a cardboard receptacle. The container may be round, rectangular, square, or any other shape known in the art. The term “container” is used here for convenience to describe exemplary embodiments. It is understood that the container may be any object, including non-containers. Container 500 may comprise a cap 502 removably secured to a body 504. Various embodiments of the body 504 may have an exterior surface 506 that comprises a upper label panel 508, a lower label panel 510, and a recessed surface 512 interposed between the upper label panel 508 and the lower label panel 510. As discussed below, the base label 100 may be applied to the container 500 at the recessed area 512 between the upper label panel 508 and the lower label panel 510.

In various embodiments, the top label 300 may be rotatable about the base label 100, as discussed below. In these embodiments, the upper label panel 508 and lower label panel 510 may function to restrict upward and downward movement of the top label 300 in relation to the container 500 such that the top label 300 generally remains in a position covering at least a portion of the base label 100.

FIG. 5B illustrates the container 500 with the base label 100 affixed to the container 500. Initially, as illustrated in FIG. 5A, base label leading edge 102 is placed in contact with the recessed surface 512 of the container 500 and affixed to the container 500 by the leading edge adhesive strip 202. With relative motion between the container 500 and the base label 100, the base label 100 may be wrapped around the container 500 with the base label trailing edge 104 now overlapping the base label leading edge 102 such that the leading edge adhesive strip 202 holds the base label leading edge 102 to the container 500 while the trailing edge adhesive strip 204 holds the base label trailing edge 104 to the overlapped base label leading edge 102.

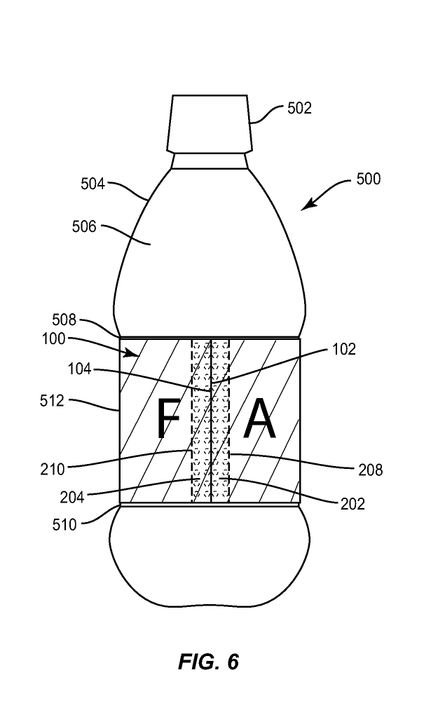

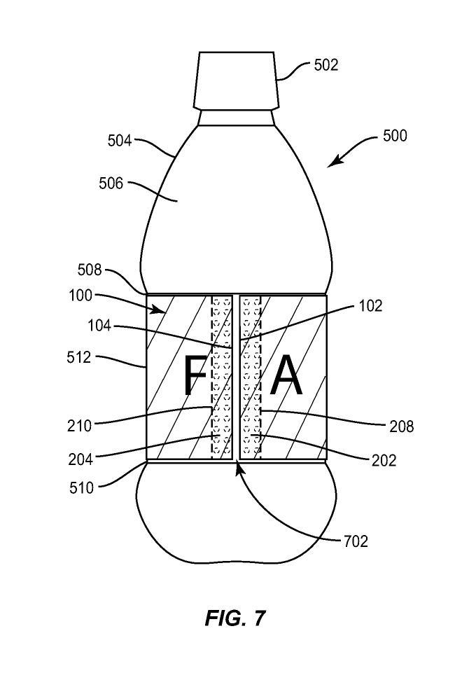

In various embodiments as illustrated in FIG. 6, the length of the base label 100 may be substantially the same as a circumference of the recessed surface 512 of the container 500, which may allow the base label leading edge 102 and base label trailing edge 104 to abut rather than overlap. However, it is also possible that the length of the base label 100 may be shorter than the circumference of the recessed surface 512, resulting in a gap 702 between the base label leading edge 102 and the base label trailing edge 104 when the base label 100 is affixed to the recessed surface as illustrated in FIG. 7. In both of these instances, the base label trailing edge adhesive strip 204 may adhere to the recessed surface 512 of the container 500, rather than the base label leading edge 102.

In various embodiments, the base label adhesive strips 202, 204 may comprise a permanent adhesive. In general, a permanent adhesive is one that does not readily release from a surface to which it adheres after the adhesive dries or cures. Using the base label 100 as an example, the permanent adhesive 202, 204 will tend not to release from the recessed surface 512, nor will it tend to release the base label leading edge 102 or trailing edge 104 once dried or cured. In order to remove the base label from the recessed surface 512, the base label 100 may have to be torn from the adhesive, or the adhesive layer 202, 204 may have to be fractured which may leave some of the adhesive on the recessed surface 512 and some of the adhesive on the base label leading edge 102 or trailing edge 104. Once the surfaces affixed with the permanent adhesive are separated, they may not be reattached.

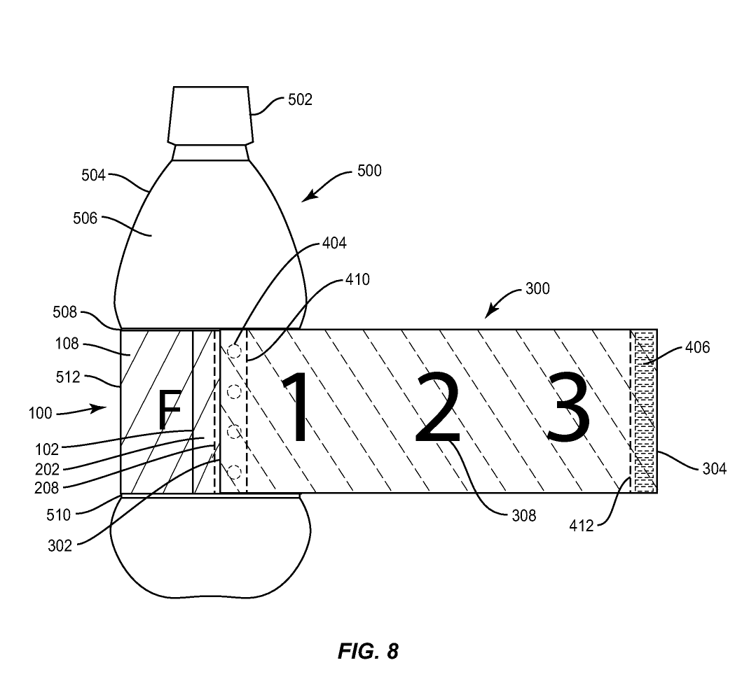

In FIG. 8, the base label 100 is already affixed to the recessed surface 512 of the container 500, and the application of the top label 300 over the base label 100 is illustrated according to various embodiments. The top label leading edge 302 may be placed in contact with any portion of the base label front surface 108 and affixed to the base label front surface 108 by the top label leading edge adhesive strip 404. With relative motion between the container 500 and the top label 300, the top label 300 may be wrapped around the container 500 with the top label trailing edge 304 now overlapping the top label leading edge 302 such that the top label leading edge adhesive strip 404 holds the top label leading edge 302 to the base label 100 while the top label trailing edge adhesive strip 406 holds the top label trailing edge 304 to the overlapped top label leading edge 302.

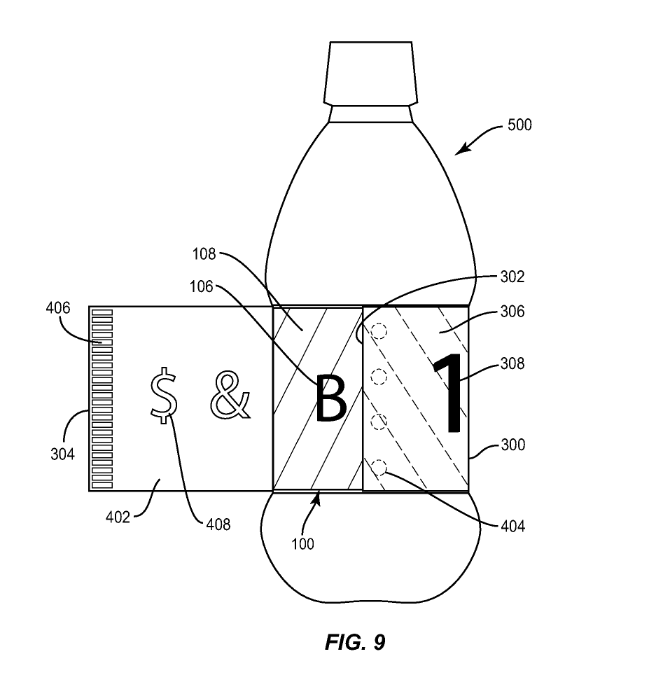

FIG. 9 illustrates the operation of the base label 100 and the top label 300 according to various embodiments. Beginning with the container 500 with the base label 100 and the top label 300 in place as shown, for example, in FIG. 6, the top label trailing edge 304 may be detached from the top label leading edge 302 and at least partially peeled back as shown in FIG. 9. The combination of the base label 100 and the top label 300 in this configuration increases the amount of surface area available for viewing by a consumer or user of the container 500. Prior to detaching the top label trailing edge 304, the consumer may view the top label front surface 306. Upon detaching the top label trailing edge 304, the consumer may now view the top label back surface 402 and the base label front surface 108 in addition to the top label front surface 306.

One of at least three types of adhesive may be used for the top label leading edge adhesive 404. A first type of adhesive is the permanent adhesive as described above for the base label 100. When a permanent adhesive is used for the top label leading edge adhesive 404, the top label leading edge generally cannot be detached without inflicting damage to one or both of the top label 300 or the base label 100. This may be desirable for various embodiments where the top label 300 is not intended to be removed from the container 500.

A second type of adhesive that may be used for the top label leading edge adhesive 404 is a releasable adhesive. A releasable adhesive is one that will release from a surface to which it is attached once a sufficient mechanical force is applied. A releasable adhesive may be used, for example, when the top label back surface 402 comprises a coupon for a subsequent purchase of a product. The releasable adhesive may allow the consumer to easily remove the top label 300 for later use. In various embodiments, the releasable adhesive may be a breakaway adhesive. A breakaway adhesive may have limited ability to withstand shear stresses. Shear stresses may cause the adhesive bond created between the label (e.g., top label 300) and the surface to which it is affixed (e.g., the base label 100 or container 500) to fail along the adhesive. In general, a releasable or breakaway adhesive may not re-attach to a surface once removed.

A third type of adhesive that may be used for the top label leading edge adhesive 404 is a resealable adhesive. A resealable adhesive may release from a surface to which it is attached once a sufficient mechanical force is applied, similar to the releasable adhesive described above. However, the resealable adhesive may be re-attached to a surface by applying pressure. A resealable adhesive may be desirable when the top label back surface 402 or the base label front surface 108 comprise information that may be needed only on occasion. Thus, the consumer or user may detach the top label 300 when the information is needed, then re-attach the top label 300.

In various embodiments, the top label trailing edge adhesive 406 may be a releasable adhesive or a resealable adhesive, depending on the intended use of the top label 300. As described above, if the surfaces 108, 402 comprise information that is intended to stay with the container, the top label trailing edge adhesive 406 may be a resealable adhesive. In contrast, if the top label 300 is intended to be removed from the container 500, a releasable adhesive may be desirable.

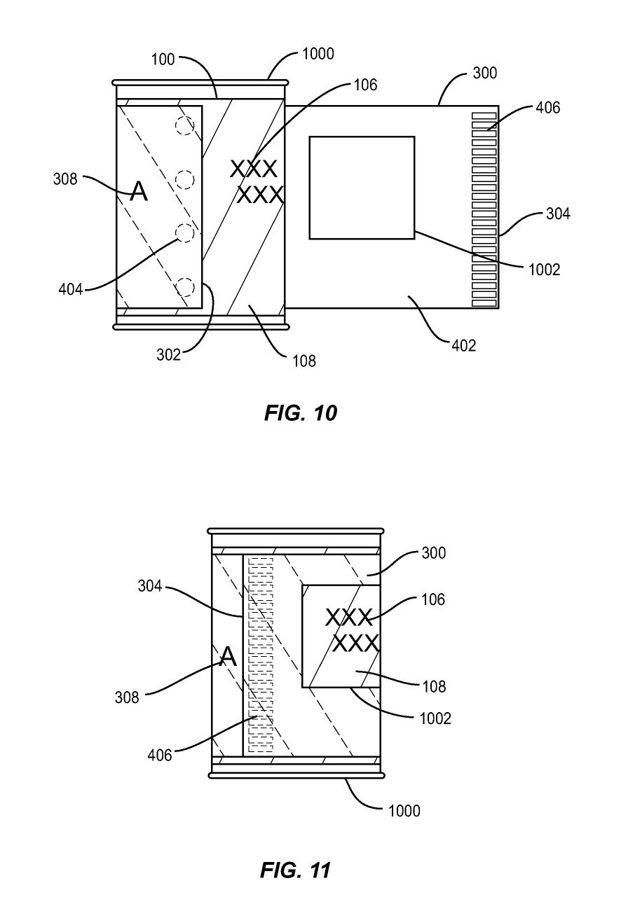

FIG. 10 illustrates various embodiments of the top label 300 comprising a window 1002. The window 1002 may comprise a void in the top label 300 such that a portion of the base label 100 may be visible through the window. In various embodiments, the window 1002 may have a transparent covering (not shown). In various other embodiments, the window may comprise a transparent section of the top label 300 itself rather than a void. FIG. 10 illustrates the top label 300 partially wrapped about a container 1000, and base label 100 already in place on the container 1000. As shown, the top label leading edge adhesive 404 maintains the top label 300 coupled to the base label 100. The top label 300 may then be moved from the position illustrated in FIG. 10 to the position illustrated in FIG. 11 to secure the top label 300 about the container 1000. Top label trailing edge adhesive 406 may couple to the top label leading edge 302 if the top label leading edge 302 and trailing edge 304 overlap; otherwise, the top label trailing edge adhesive 406 may be coupled to the base label front surface 108.

Once the top label 300 is in position on the container 1000 as illustrated in FIG. 11, at least a portion of the base label front surface indicia 106 may be visible through the window 1002. This may allow viewing of a first portion of the base label 100 without removing the top label 300. In various embodiments, the top label leading edge adhesive 404 may be a breakaway adhesive. Rotation of the top label 300 relative to the base label 100 may exert shear stresses on the breakaway adhesive, causing the adhesive bond affixing the top label leading edge 302 to the base label 100 to fail. The top label 300 may then be freely rotatable about the base label 100, and a second portion of the base label 100 may be visible when the top label 300 is rotated to a second position. The window 1002 may be rectangular as illustrated in FIGS. 10 and 11, or any other shape as needed for a particular application. For example, the window 1002 may be a slit that reveals an alphanumeric string on the base label 100. In various embodiments, the top label 300 may comprise more than one window 1002. Various embodiments in which the top label trailing edge adhesive 406 is a resealable or releasable adhesive may allow the top label 300 to be peeled back to reveal the top label back surface 402 and essentially the entire base label front surface 108 or to be removed from the container 1000, in addition to being rotatable.

One skilled in the art will readily recognize that labels may be applied to containers using a variety of methods and that there may be a variety of single-label and multi-label systems other than those described above. Any such application methods or label systems may be used with the present disclosure. The above descriptions are exemplary and not to be construed as limiting in any way. Examples of other application methods and label systems may be disclosed in U.S. Pat. Nos. 5,884,421, 6,086,697, 6,237,269, 6,402,872, 6,631,578, 6,649,007, 7,087,298, and 7,172,668.

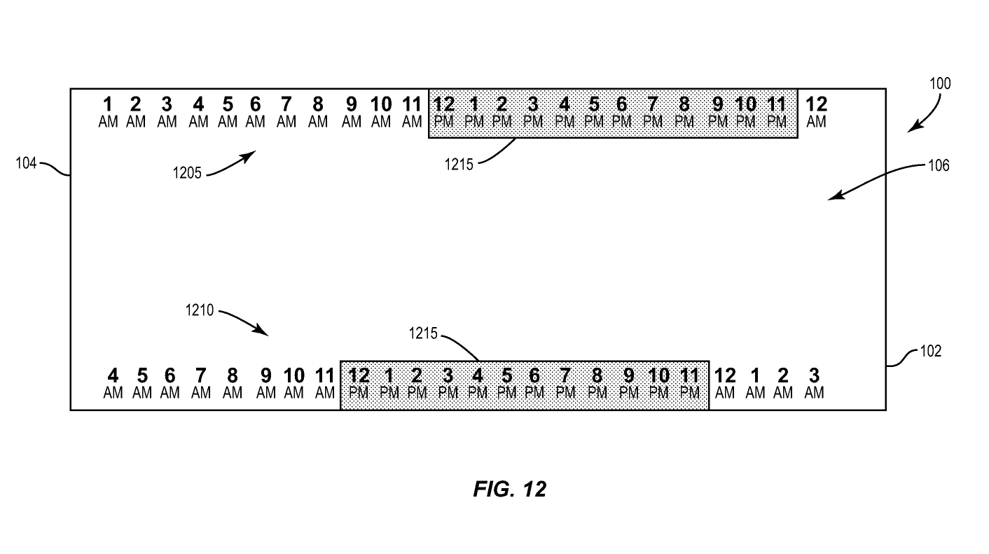

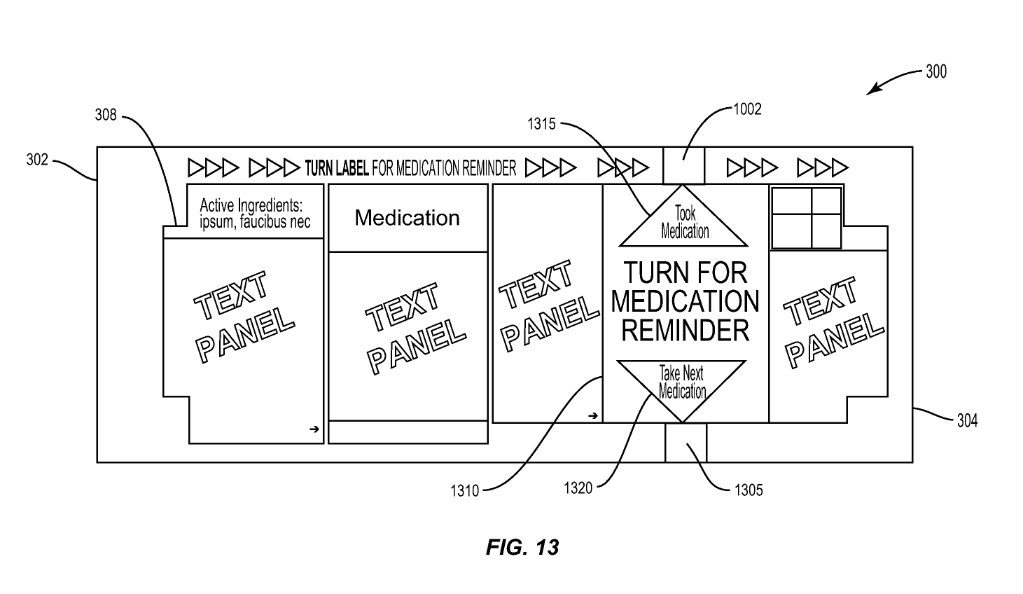

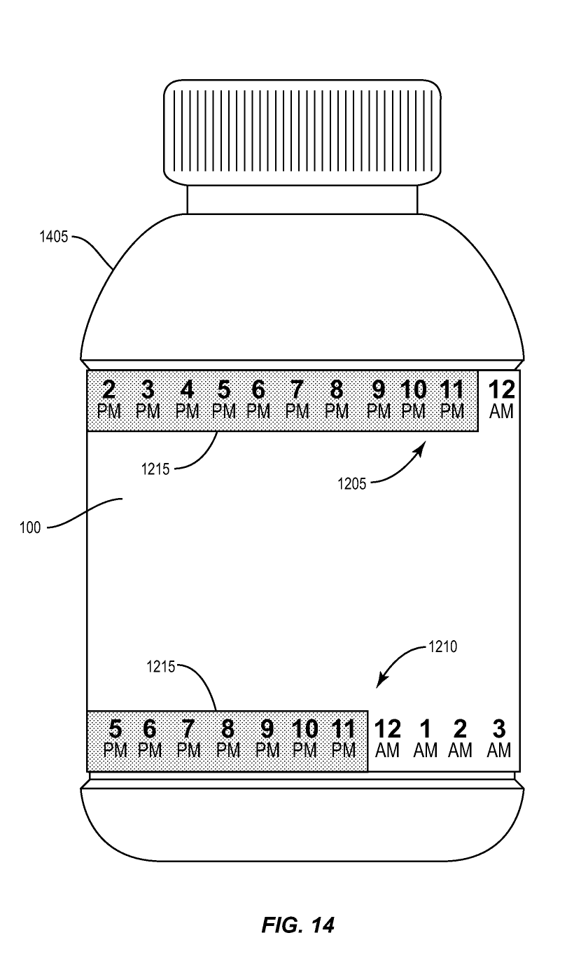

FIGS. 12 and 13 illustrate a base label 100 and top label 300, respectively, that may comprise a label reminder system for a container, such as a medication container 1405 (see FIG. 14) according to various embodiments. The base label indicia 106 may comprise a first set of reminder information 1205 and a second set of reminder information 1210 printed thereon. As illustrated in the exemplary embodiments of FIG. 12, the first and second sets of reminder information 1205, 1210 may comprise a plurality of indicia corresponding to the hours of a day. The first and second sets of reminder information 1205, 1210 may visually distinguish AM hours from PM hours to avoid confusion by a user of the label reminder system. For example, the first and second sets of reminder information 1205, 1210 may comprise a shaded portion 1215 to indicate the PM hours.

In various embodiments, the top label 300 may contain a transparent window 1002 as described previously (see FIG. 10), as well as a second transparent window 1305. At least one of the plurality of indicia of the first set of reminder information 1205 may be displayed in the first transparent window 1002 and may represent a first time when material previously found in the container 1405 was dispensed. The second transparent window 1305 may display at least one of the plurality of indicia of the second set of reminder information 1210 and may represent a second time when material currently in the container 1405 is to be dispensed.

The top label 300 may comprise indicia 308 relaying product-related information, safety-related information, manufacturer-related information, and the like. The top label indicia 308 may comprise an instruction section 1310 to aid the user in the use and interpretation of the indicia of the first and second sets of reminder information 1205, 1210 visible in the transparent windows 1002, 1305. As discussed more fully below, the instruction section 1310 may comprise a first instruction 1315 corresponding to the first set of reminder information 1205 and a second instruction 1320 corresponding to the second set of reminder information 1210.

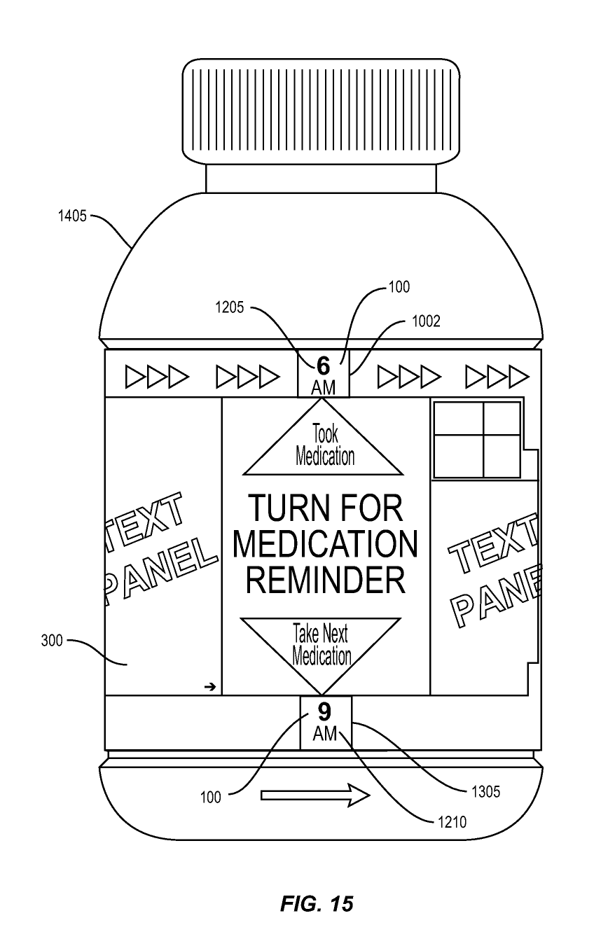

FIG. 14 illustrates the base label 100 positioned on the container 1405 according to various embodiments. As discussed above, the base label 100 may comprise first and second sets of reminder information 1205, 1210 printed on the front surface 108 such that the first and second sets of reminder information 1205, 1210 at least partially encircle the container 1405. FIGS. 15 through 17 illustrate the top label 300 in place over the base label 100 on the container 1405 according to various embodiments. The base label 100 and the top label 300 may comprise a label reminder system that may be used, for example, on a medication container 1405 to provide additional functionality that may allow a user to more readily remember when a next dose should be taken.

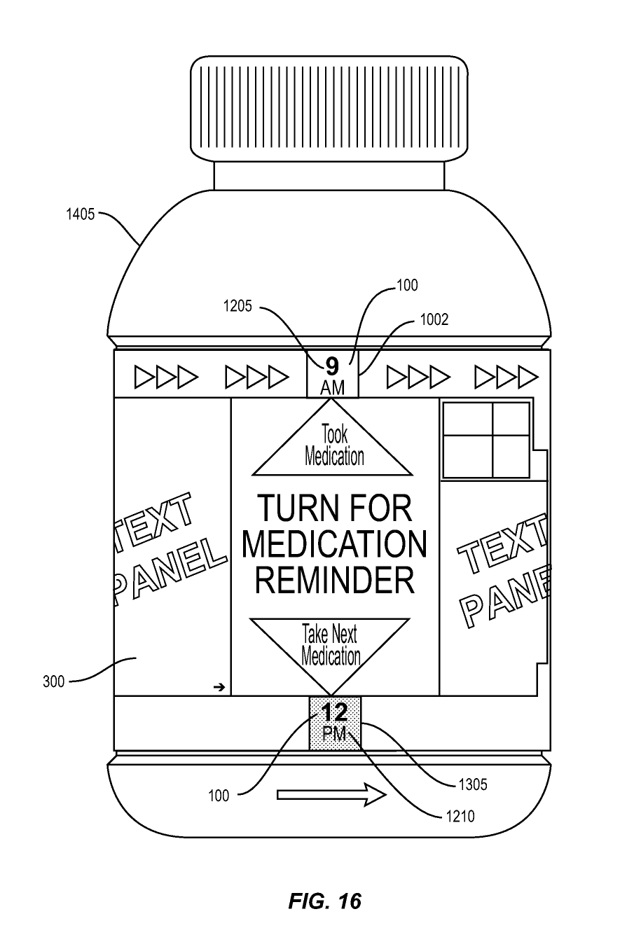

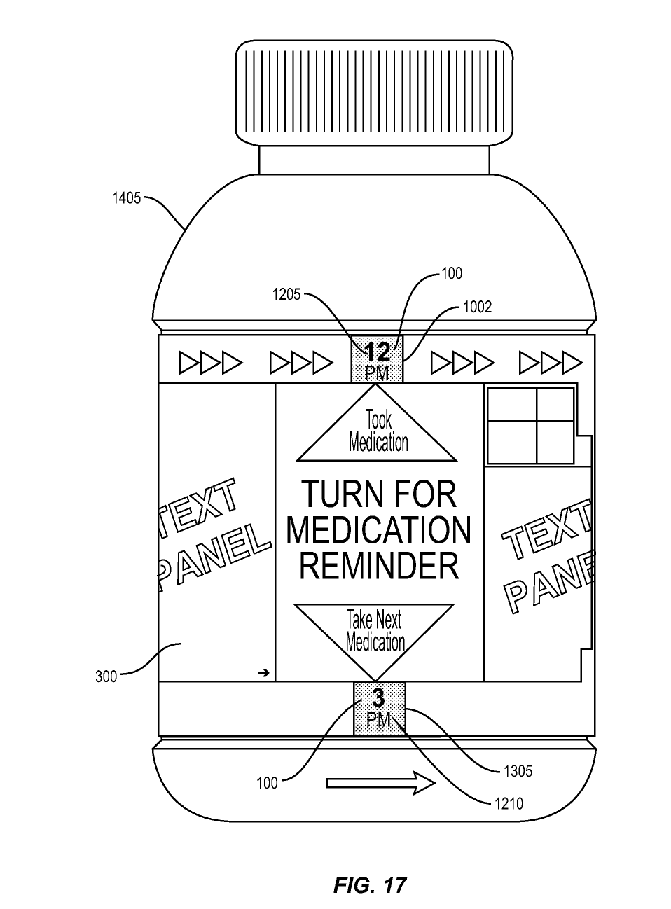

FIG. 15 illustrates the top label 300 in place over the base label 100. As described previously, the top label 300 may be applied such that the top label 300 is rotatable around a circumference of the container 1405. In FIG. 15, the top label 300 has been rotated in the direction of the arrow revealing at least one of the indicia comprising the first set of reminder information 1205 through the first transparent window 1002 and at least one of the indicia comprising the second set of reminder information 1210 through the second transparent window 1305. Similarly, FIGS. 16 and 17 illustrate the top label 300 further rotated in the direction of the arrow, thus revealing a different one of the first set of reminder information 1205 indicia through the first transparent window 1002 and a different one of the second set of reminder information 1210 indicia through the second transparent window 1305. Although FIGS. 15 through 17 illustrate a single indicia of the first and second sets of reminder information 1205,1210 visible through the transparent windows 1002, 1305, two or more indicia may simultaneously be visible through the transparent windows 1002, 1305 in various embodiments.

The operation of the label reminder system according to various embodiments is illustrated in FIGS. 15 through 17. By way of example, the user may take a first dose of the product in the container 1405 at 6 AM. The user may then rotate the outer label 300 until the indicia of the first set of reminder information 1205 for “6 AM” is visible in the first transparent window 1002 to indicate when the dose was taken. As discussed previously, the instruction section 1310 of the top label 300 may comprise first instruction 1315 associated with the indicia displayed in the first transparent window 1002, such as “Took Medication” or other similar instruction. The first instruction 1315 may guide the user to rotate the top label 300 until the time when the most recent dose was removed from the container 1405 is displayed in the first transparent window 1002 (“6 AM” as illustrated in FIG. 15). When the outer label 300 is rotated to display the desired indicia in the first transparent window 1002, a corresponding indicia of the second set of reminder information 1210 may simultaneously be displayed in the second transparent window 1305. The indicia displayed in the second transparent window 1305 may correspond to a future time when material currently in the container 1405 is to be dispensed. The second instruction 1320 of the instruction section 1310 may be associated with the indicia displayed in the second transparent window 1305, and may display an instruction such as “Take Next Medication” or other similar instruction. The second instruction 1320 may guide the user as to when the next dose of medication should be dispensed from the container 1405.

In the example of FIG. 15, the indicia displayed in the second transparent window 1305 indicates that the next dose should be dispensed form the container 1405 at 9 AM. Once the dose is dispensed, the user may then rotate the top label 300 to the position shown in FIG. 16 such that “9 AM” is displayed in the first transparent window 1002. In this example, the next dose should be dispensed at 12 PM as indicated by the indicia displayed in the second transparent window 1305.

Once the 12 PM dose is dispensed, the user may again rotate the top label 300 until “12 PM” is displayed in the first transparent window 1002 as shown in FIG. 17. Now the second transparent window 1305 displays “3 PM” which is the designated time for the next dose to be dispensed. This procedure may be repeated until all medication is dispensed from the container 1405.

Referring back to FIG. 12, the indicia of the first and second sets of reminder information 1205, 1210 may be vertically aligned with one another according to a predetermined pattern. In the example of FIG. 12, this pattern is exemplified as an offset such that the hour indicia of the second set of reminder information 1210 is three hours in advance of the hour indicia of the first set of reminder information 1205 directly above. For example, the indicia 1 AM in the first set of reminder information 1205 is vertically aligned with 4 AM in the second set of reminder information 1210. Referring now to FIG. 13, the first and second transparent windows 1002, 1305 are shown in vertically alignment with one another. Thus, when a specific indicia of the first set of reminder information 1205 is displayed in the first transparent window 1002, the second transparent window 1305 may display the indicia of the second set of reminder information 1210 vertically aligned with the specific indicia. For example, the indicia “3 AM” may be displayed in the second transparent window 1305 when the indicia “1 AM” is displayed in the first transparent window 1002. The amount of this “offset” may correspond to the amount of time between each dispensing of material from the container 1405.

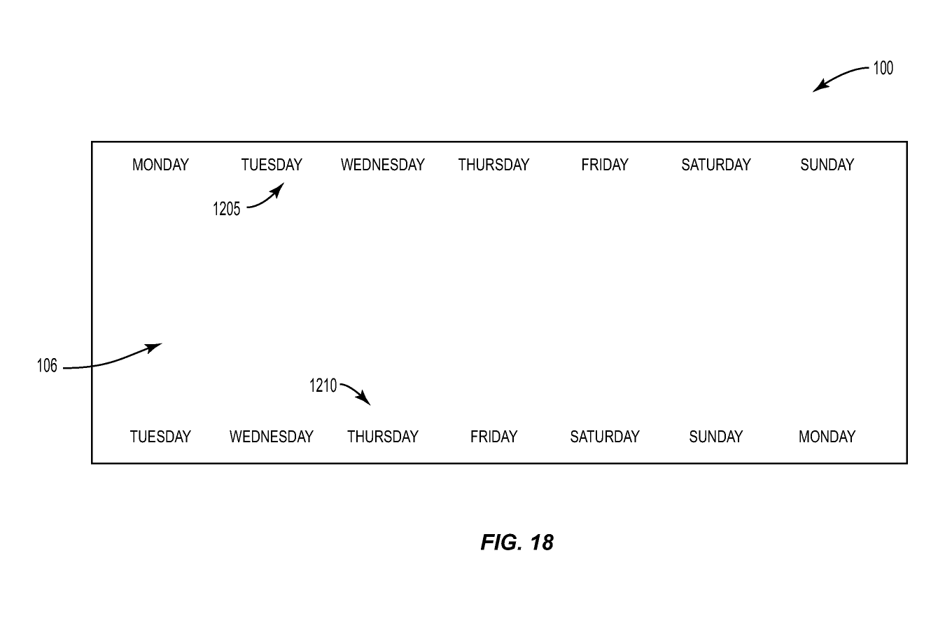

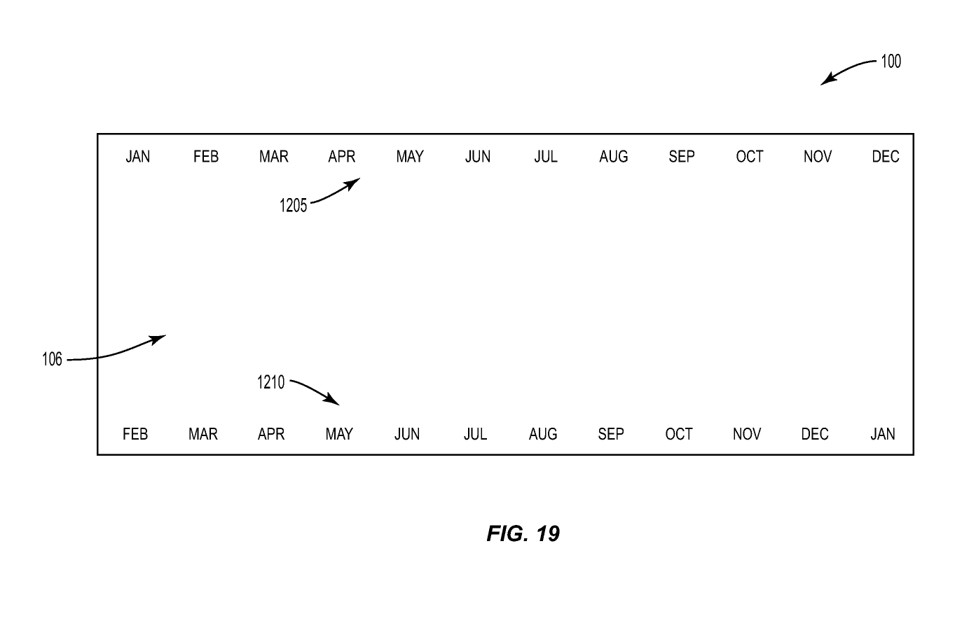

The various embodiments of the base label 100 illustrated in FIG. 12 may be used when the amount of time between each dispensing of material from the container 1405 is less than one day (e.g., measured in a number of hours less than 24). However, the time between each dispensing may be longer than one day and may require the indicia of the first and second sets of reminder information 1205, 1210 to be other than hours. For example, FIG. 18 illustrates days of the week and FIG. 19 illustrates months of the year as the indicia of the first and second sets of reminder information 1205, 1210. One skilled in the art will readily recognize that the indicia may correspond to any measure of time, and the representation of the measure of time may be accomplished with alphanumeric characters, graphs, symbols, and the like.

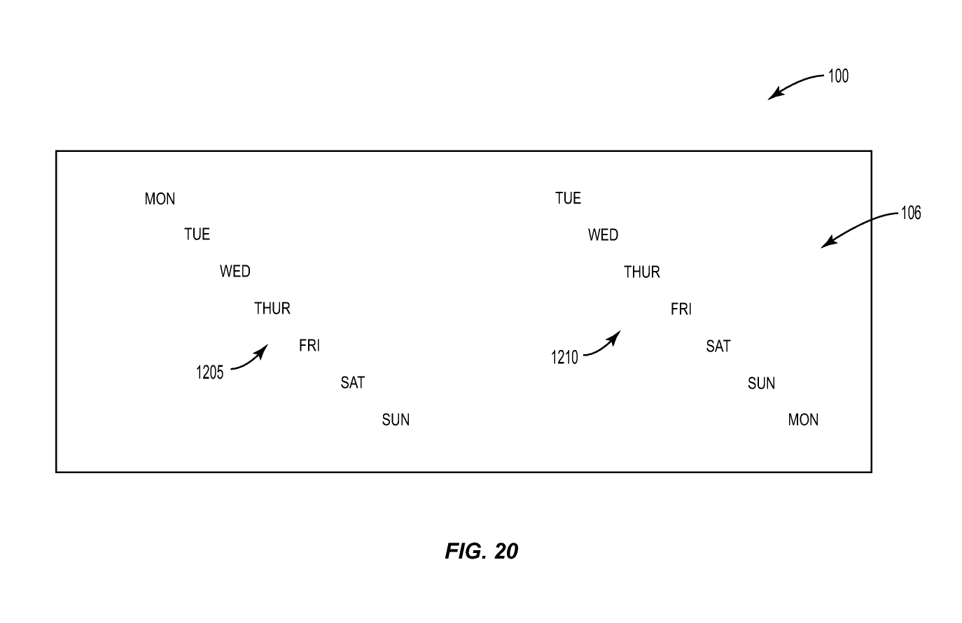

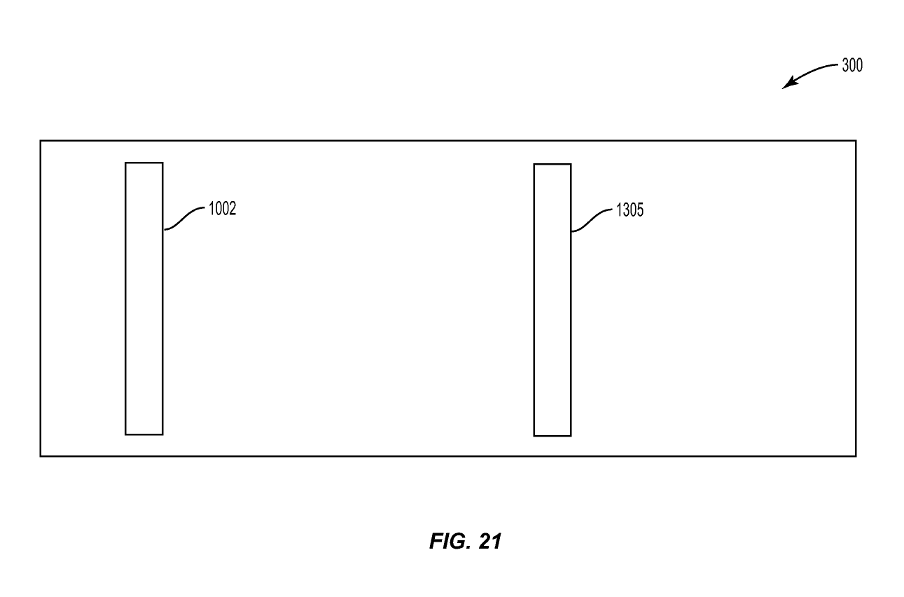

Although FIGS. 12 and 13 illustrate various embodiments of a label reminder system where the first and second sets of reminder information 1205, 1210 are aligned in essentially parallel horizontal rows, other orientations are within the scope of the present disclosure. For example, FIGS. 20 and 21 illustrate various embodiments in which the first and second sets of reminder information 1205, 1210 are arranged in angled rows across the base label 100. In this example, the first and second transparent windows of the top label 300 may be vertically oriented slots in order to display indicia at any vertical position on the base label 100.

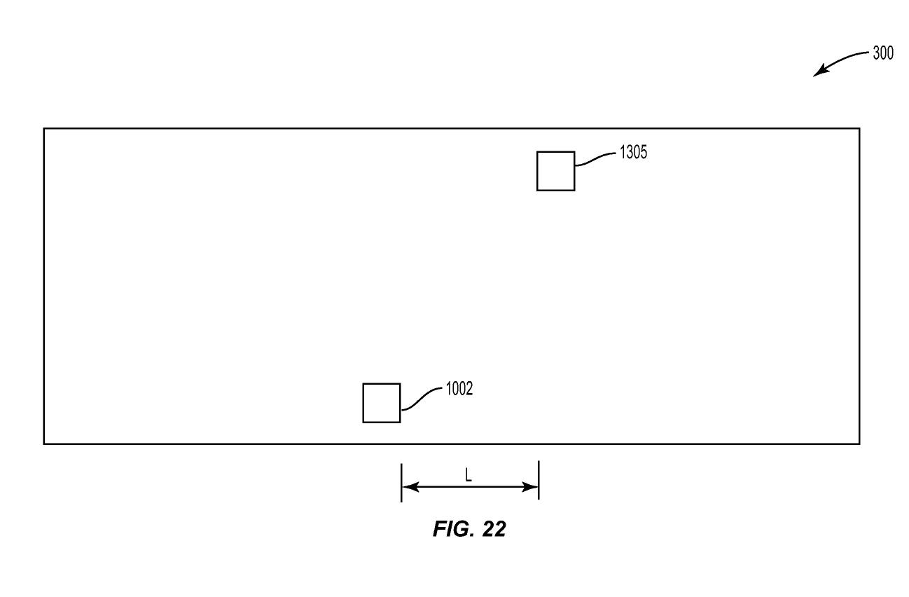

In yet other embodiments, the first and second transparent windows 1002, 1305 may be offset from one another by a distance L as illustrated in FIG. 22. This arrangement of the transparent windows may be used with a base label 100 in which there is no offset in the first and second sets of reminder information 1205, 1210 (i.e., “1 AM” in the first set of reminder information 1205 is vertically aligned with “1 AM” in the second set of reminder information 1210). Thus, the base label 100 may be “generic” and the top label 300 selected such that the offset distance L between the first and second transparent windows 1002, 1305 corresponds to the amount of time between each dispensing of material from the container 1405.

In the embodiments of base label 100 described above, the interval between each successive indicia of the first and second sets of reminder information 1205, 1210 may be fixed. For example, the interval between each successive indicia as illustrated in FIG. 12 is one hour. However, the dosage of some medications may change over time such that the interval between indicia may not be fixed. For example, the first and/or second sets of reminder information 1205, 1210 may be: 1 AM, 2 AM, 4 AM, 8 AM, 4 PM. In other embodiments, the interval between the indicia may be fixed for a portion of the first or second set of the reminder information 1205, 1210 and not fixed for another portion.

The top label 300 may comprise a dual ply (or multi-ply) construction in which a ply in contact with the base label 100 is a material selected for low sliding friction characteristics. The low sliding friction characteristics may enhance the ease of rotating and sliding the top label 300 about the base label 100. In various embodiments, the top label 300 ply in contact with the base label 100 may be coated with a substance to impart the low sliding friction characteristics.

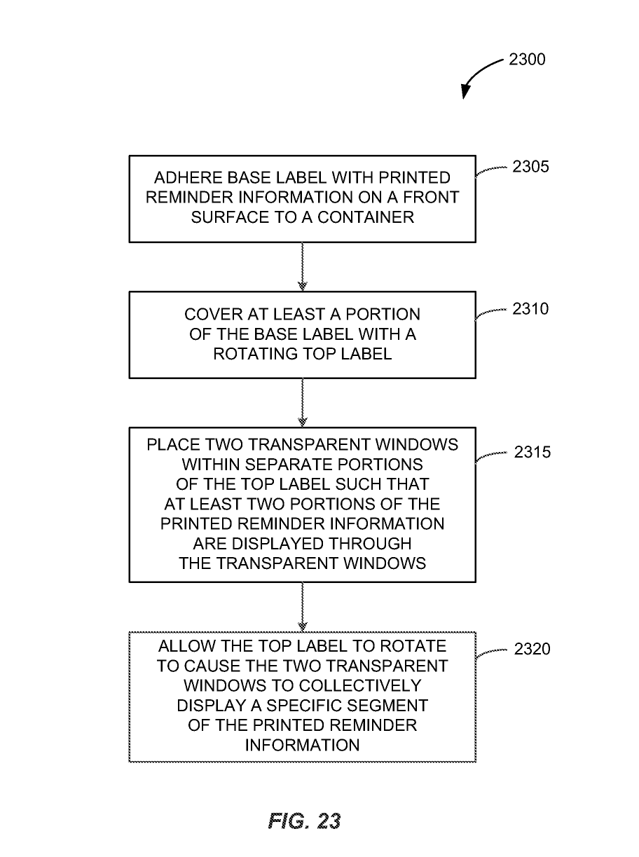

FIG. 23 illustrates a general flow chart of various embodiments of a method 2300 for generating a rotating label reminder system for a container. A base label 100 may be applied to a container 1405 (step 2305). The base label 100 may have a back surface 206 and a front surface 108. A plurality of indicia comprising reminder information 1205, 1210 may be printed on the front surface 108 of the base label 100. Referring, for example, to FIG. 12, the reminder information 1205, 1210 may comprise indicia for the hours in a day. In various embodiments, the reminder information 1205, 1210 may comprise indicia for days in a week, months in a year, and the like. At step 2310, at least a portion of the base label 100 may be covered with a rotating top label 300. In various embodiments, the base label 100 may be coupled to the container 1405 while the top label 300 is free to rotate about the base label 100. Two transparent windows 1002, 1305 may be placed within a portion of the rotating top label 300 at step 2315 such that at least two portions of the printed reminder information 1205, 1210 are visible through the transparent windows 1002, 1305. As the top label 300 is rotated about the base label 100, one or more of the other specific indicia of the printed reminder information 1205, 1210 may alternately be visible through the transparent windows 1002, 1305. In various embodiments, more than one indicia of the printed reminder information 1205, 1210 may be visible through each the two transparent windows 1002, 1305. The top label 300 may be allowed to rotate at step 2320 to cause the two transparent windows 1002, 1305 to collectively display a specific segment of the printed reminder information 1205, 1210.

In various embodiments, all or a portion of the indicia 106 may be imprinted, embossed, or molded directly on an outer surface of the container 1405 in place of all or a portion of the base label 100. The imprinting or embossing may be carried out using any printing or image transfer method known in the art. In various embodiments, the printing or image transfer method may be an offset process in which an image is transferred from a plate to an intermediate carrier, then to the outer surface of the container 1405. The offset process may also involve lithographic techniques. Other printing or image transfer methods may comprise, for example, flexography, pad printing, relief printing, rotogravure, screen printing, and electrophotography. According to various embodiments, the indicia 106 may be digitally printed on the outer surface of the container 1405 using, for example, inkjet printing or laser printing. Chemical printing technologies, such as blueprint or diazo print may also be used in various embodiments.

Spatially relative terms such as “under”, “below”, “lower”, “over”, “upper”, and the like, are used for ease of description to explain the positioning of one element relative to a second element. These terms are intended to encompass different orientations of the device in addition to different orientations than those depicted in the figures. Further, terms such as “first”, “second”, and the like, are also used to describe various elements, regions, sections, etc. and are also not intended to be limiting. Like terms refer to like elements throughout the description.

As used herein, the terms “having”, “containing”, “including”, “comprising”, and the like are open ended terms that indicate the presence of stated elements or features, but do not preclude additional elements or features. The articles “a”, “an” and “the” are intended to include the plural as well as the singular, unless the context clearly indicates otherwise.

The present invention may be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A rotating label reminder system for a container, comprising:
a base label adhered to the container, the base label having a front surface with printed reminder information;
an opaque rotating top label covering at least a portion of the front surface of the base label;
two transparent windows within separate portions of the opaque rotating top label, the two transparent windows displaying at least two portions of the printed reminder information; and
wherein rotation of the opaque rotating top label causes the two transparent windows to collectively display a specific segment of the printed reminder information.

2. The system of claim 1, wherein the specific segment of the printed reminder information includes a first indicia representing a first time when material previously found within the container was dispensed, and a second indicia representing a second time when material currently within the container is to be dispensed.

3. The system of claim 1, wherein the printed reminder information comprises hours of the day.

4. The system of claim 1, wherein the printed reminder information comprises a first set of reminder information and a second set of reminder information.

5. The system of claim 4, wherein one of the transparent windows displays a portion of the first set of reminder information and the other transparent window displays a portion of the second set of reminder information.

6. The system of claim 4, wherein the first set of reminder information is offset from the second set of reminder information.

7. The system of claim 6, wherein an amount of the offset is related to a length of time between successive dispensing of material within the container.

8. The system of claim 2, wherein the material is a liquid, a solid or any combination thereof.

9. A method for generating a rotating label reminder system for a container, comprising:
adhering a base label to the container, the base label having a front surface with printed reminder information;
covering at least a portion of the front surface of the base label with an opaque rotating top label;
placing two transparent windows within separate portions of the opaque rotating top label, the two transparent windows displaying at least two portions of the printed reminder information; and
allowing the opaque rotating top label to rotate, causing the two transparent windows to collectively display a specific segment of the printed reminder information.

10. The method of claim 9, wherein the specific segment of the printed reminder information includes a first indicia representing a first time when material previously found within the container was dispensed, and a second indicia representing a second time when material currently within the container is to be dispensed.

11. The method of claim 9, wherein the printed reminder information comprises a first set of reminder information and a second set of reminder information.

12. The method of claim 10, wherein the material is a liquid, a solid or any combination thereof.

13. A rotating label reminder system for a container, comprising:
printed reminder information on a surface of the container;
an opaque rotating top label covering at least a portion of the front surface of the container;
two transparent windows within separate portions of the opaque rotating top label, the two transparent windows displaying at least two portions of the printed reminder information; and
wherein rotation of the opaque rotating top label causes the two transparent windows to display a specific segment of the printed reminder information.

14. The system of claim 13, wherein the specific segment of the printed reminder information includes a first indicia representing a first time when material previously found within the container was dispensed, and a second indicia representing a second time when material currently within the container is to be dispensed.

15. The system of claim 14, wherein the second time represents an immediately successive time after the first time for dispensing the material currently within the container.

16. The system of claim 15, wherein a difference between the first time and the second time represents a dispensing interval.

17. The system of claim 16, wherein the dispensing interval is fixed or constant for each specific segment of the printed reminder information.

18. The system of claim 16, wherein the dispensing interval is not fixed or not constant for at least one specific segment of the printed reminder information.

19. The system of claim 14, wherein the first indicia and the second indicia include an AM or PM designation.

20. The system of claim 14, wherein further unidirectional rotation of the opaque rotating top label causes the two transparent windows to display a second specific segment of the printed reminder information.

21. The system of claim 20, wherein the second specific segment of the printed reminder information includes a third indicia representing a third time when material previously found within the container was dispensed or is to be dispensed, and a fourth indicia representing a fourth time when material currently within the container is to be dispensed.

22. The system of claim 13, wherein the at least two portions of the printed reminder information comprise the specific segment of the printed reminder information.
